(19) United States
(12) Patent Application Publication
(10) Pub. No.: US 2022/0165024 A1
(43) Pub. Date: May 26, 2022

(54) TRANSFORMING STATIC TWO-DIMENSIONAL IMAGES INTO IMMERSIVE COMPUTER-GENERATED CONTENT

(71) Applicant: AT&T Intellectual Property I, L.P., Atlanta, GA (US)

(72) Inventors: Eric Zavesky, Austin, TX (US); Tan Xu, Bridgewater, NJ (US); Jean-Francois Paiement, Sausalito, CA (US)

(21) Appl. No.: 17/103,848

(22) Filed: Nov. 24, 2020

(51) Int. Cl. G06T 17/00; G06T 15/02; G06T 19/20; G06K 9/46

(52) U.S. Cl. CPC G06T 17/00; G06T 15/02; G06K 2209/01; G06K 9/46; G06T 2200/24; G06T 19/20

(57) ABSTRACT

A method for transforming static two-dimensional images into immersive computer generated content includes various operations performed by a processing system including at least one processor. In one example, the operations include extracting a plurality of physical features of a media asset from a plurality of two-dimensional images of the media asset, constructing a three-dimensional model of the media asset, based on the plurality of physical features, extracting a plurality of narrative elements associated with the media asset from the plurality of two-dimensional images of the media asset, building a hierarchy of a narrative for the media asset, based on at least a subset of the plurality of narrative elements, and creating an immersive experience based on the three-dimensional model and the hierarchy of the narrative.

The present disclosure relates generally to immersive media, and relates more particularly to devices, non-transitory computer-readable media, and methods for transforming static two-dimensional images into immersive computer generated content.

### BACKGROUND

Much of the media that has been produced in the past, and even much of the media that is currently being produced, exists in a static, two-dimensional format. For instance, media including historical works of art (e.g., paintings, drawings, mixed media), comic strips, graphic novels, and book illustrations may exist exclusively in two dimensional form.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for transforming static two-dimensional images into immersive computer generated content may operate;

FIG. 2 illustrates a flowchart of an example method for transforming static two-dimensional images into immersive computer generated content, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for transforming static two-dimensional images into immersive computer generated content. A method for transforming static two-dimensional images into immersive computer generated content includes various operations performed by a processing system including at least one processor. In one example, the operations include extracting a plurality of physical features of a media asset from a plurality of two-dimensional images of the media asset, constructing a three-dimensional model of the media asset, based on the plurality of physical features, extracting a plurality of narrative elements associated with the media asset from the plurality of two-dimensional images of the media asset, building a hierarchy of a narrative for the media asset, based on at least a subset of the plurality of narrative elements, and creating an immersive experience based on the three-dimensional model and the hierarchy of the narrative.

In another example, a non-transitory computer-readable medium may store instructions which, when executed by a processing system in a communications network, cause the processing system to perform operations. The operations may include extracting a plurality of physical features of a media asset from a plurality of two-dimensional images of the media asset, constructing a three-dimensional model of the media asset, based on the plurality of physical features, extracting a plurality of narrative elements associated with the media asset from the plurality of two-dimensional images of the media asset, building a hierarchy of a narrative for the media asset, based on at least a subset of the plurality of narrative elements, and creating an immersive experience based on the three-dimensional model and the hierarchy of the narrative.

In another example, a device may include a processing system including at least one processor and a non-transitory computer-readable medium storing instructions which, when executed by the processing system when deployed in a communications network, cause the processing system to perform operations. The operations may include extracting a plurality of physical features of a media asset from a plurality of two-dimensional images of the media asset, constructing a three-dimensional model of the media asset, based on the plurality of physical features, extracting a plurality of narrative elements associated with the media asset from the plurality of two-dimensional images of the media asset, building a hierarchy of a narrative for the media asset, based on at least a subset of the plurality of narrative elements, and creating an immersive experience based on the three-dimensional model and the hierarchy of the narrative.

As discussed above, much of the media that has been produced in the past, and even much of the media that is currently being produced, exists in a static (e.g., single-frame), two-dimensional format. For instance, media including historical works of art (e.g., paintings, drawings, mixed media), comic strips, graphic novels, and book illustrations may exist exclusively in two-dimensional form. As media consumption trends shift toward more immersive experiences (e.g., extended reality, three-dimensional environments, etc.), however, opportunities may be lost for consumers to experience this two-dimensional media. For instance, if the media is older, the original artists may be unavailable to produce three-dimensional versions of the media. Moreover, even new artists may have trouble translating some of the plot complexities that are conveyed in, say, the frames of a comic strip, into an immersive environment without knowledge of the common narrative threads that may run throughout the comic series (e.g., recurring gags, character interactions, etc.). Thus, a large production team may be required to manually transform a static, two-dimensional media into a three-dimensional media.

Examples of the present disclosure facilitate the conversion of a static, two-dimensional media asset into an artistically faithful, immersive (e.g., three-dimensional) computer-generated asset by automatically (or semi-automatically) detecting repeated appearances of the media asset within a set of media. For instance, the media asset may be a recurring character in a printed comic strip series, and the set of media may include several different instances of the comic strip series in which the character appeared. Based on analysis of the repeated appearances, a three-dimensional model may be constructed to simulate the media asset's appearance and/or behavior. For instance, referring again to the recurring character in the comic strip series, the model may simulate various facial expressions (e.g., happy, sad, scared, etc.), costumes (does the character always wear the same outfit or accessories?), mannerisms (e.g., catchphrases, character-specific ways of moving or emoting, such as a character who speaks with his hands a lot, etc.), responses within some context-specific scenario (e.g., whether the character is quick to anger or rarely gets angry), and other character-specific characteristics (e.g., whether the character always appears with another character and how the character interacts with the other character, etc.).

Further examples of the present disclosure detect narrative hierarchies within the set of media. Based on analysis of the narrative hierarchies, models of common narrative elements may be constructed to simulate events that may commonly occur in the set of media. For instance, recurring jokes or interactions (e.g., a character always makes an entrance in a certain way, a certain basic story structure is always followed, etc.) may be modeled as common narrative elements. The models of the common narrative elements may also indicate the roles of particular characters in the set of media (e.g., hero, villain, comic relief, etc.).

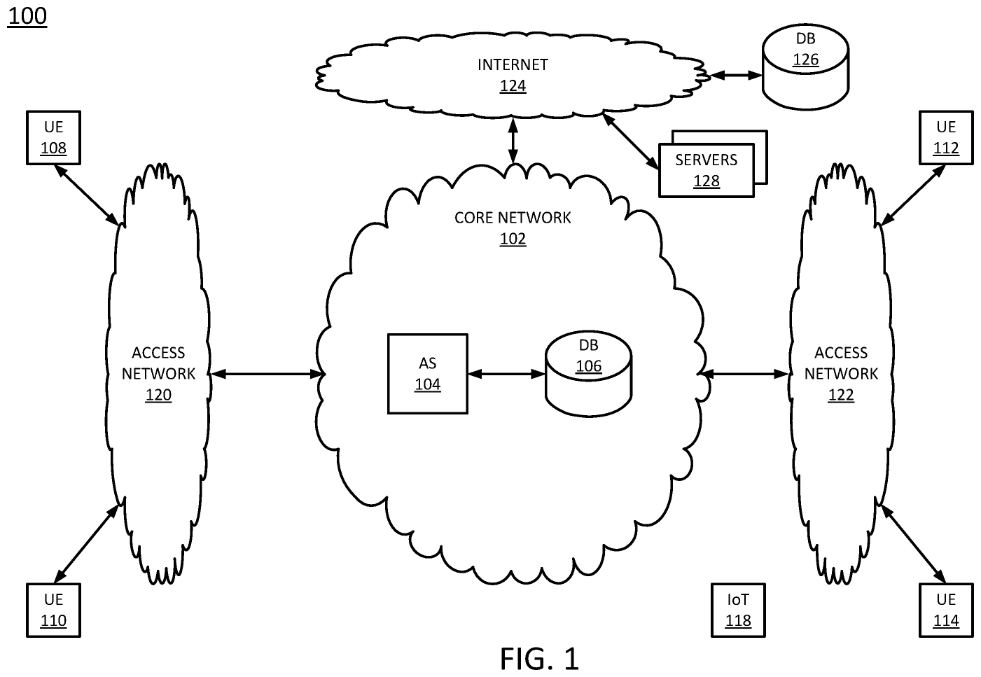

The various models that are constructed (e.g., the three-dimensional character models, the narrative element models, etc.) may be used to render an immersive experience in which a user may interact with elements of the previously static, two-dimensional media asset. These and other aspects of the present disclosure are discussed in greater detail below in connection with the examples of FIGS. 1-3.

To further aid in understanding the present disclosure, FIG. 1 illustrates an example system 100 in which examples of the present disclosure for transforming static two-dimensional images into immersive computer generated content may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104 and at least one database (DBs) 106. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114 and the AS 104, other components of the core network 102, devices reachable via the Internet in general, and so forth.

In one example, each of the user endpoint devices 108, 110, 112, and 114 may comprise any single device or combination of devices that may comprise a user endpoint device. For example, the user endpoint devices 108, 110, 112, and 114 may each comprise a mobile device, a cellular smart phone, a gaming console, a set top box, a laptop computer, a tablet computer, a desktop computer, a wearable smart device (e.g., a smart watch, smart glasses, or a fitness tracker) an application server, a bank or cluster of such devices, and the like.

In one particular example, at least one of the user endpoint devices 108, 110, 112, and 114 may comprise an immersive display. The immersive display may comprise a display with a wide field of view (e.g., in one example, at least ninety to one hundred degrees). For instance, head mounted displays, simulators, visualization systems, cave automatic virtual environment (CAVE) systems, stereoscopic three dimensional displays, and the like are all examples of immersive displays that may be used in conjunction with examples of the present disclosure. In other examples, an “immersive display” may also be realized as an augmentation of existing vision augmenting devices, such as glasses, monocles, contact lenses, or devices that deliver visual content directly to a user's retina (e.g., via mini-lasers or optically diffracted light). In further examples, an “immersive display” may include visual patterns projected on surfaces such as windows, doors, floors, or ceilings made of transparent materials.

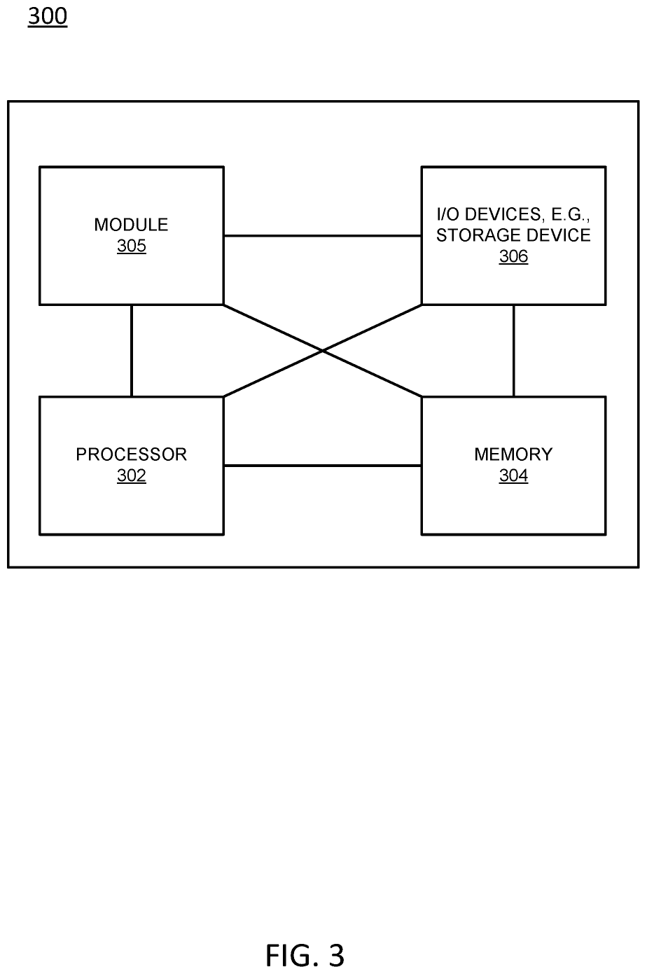

In accordance with the present disclosure, the AS 104 may be configured to provide one or more operations or functions in connection with examples of the present disclosure for transforming static two-dimensional images into immersive computer generated content, as described herein. The AS 104 may comprise one or more physical devices, e.g., one or more computing systems or servers, such as computing system 300 depicted in FIG. 3, and may be configured as described below to transform static two-dimensional images into immersive computer generated content. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the AS 104 may be configured to transform static two-dimensional images into immersive computer generated content. As discussed above, a static, two-dimensional image of a media asset may comprise, for instance, a frame of a comic strip, a page of an illustrated book, a frame or page of a graphic novel, a painting, a drawing, or the like, while the media asset may be a character, object, or the like that appears in the static, two-dimensional image. For instance, the media asset may be a regular or recurring character in a book series, a unique vehicle or accessory that appears in a comic strip series, or the like.

The AS 104 may then use the plurality of images to construct a three-dimensional model of the media asset which may be used to render an immersive experience that includes the media asset as part of the experience. For instance, a user in the immersive experience may be able to interact with the three-dimensional model of the media asset. In order to maximize the artistic faithfulness of the three-dimensional model to the media asset, the AS 104 may obtain a diverse set of two-dimensional images depicting the media asset in different situations. This may help the AS 104 to construct a three-dimensional model that not only resembles the more persistent characteristics of the media asset (e.g., a character's size, hair color and style, costume, behaviors, relationships to other characters, catchphrases, etc.), but also the more ephemeral characteristics of the media asset, or characteristics that may be more context-dependent (e.g., a character's facial expressions and reactions).

In further examples, the AS 104 may extract narrative elements from the plurality of static, two-dimensional images. For instance, a narrative element such as dialogue, recurring bits or jokes, exposition, or the like could be extracted from text on the page of an illustrated book, a thought or speech bubble associated with a character in a comic strip, or the like, where natural language processing techniques could be used to extract meaning from the text. A narrative element could also be inferred from images (e.g., an image of a character shivering may imply that it is cold out, an image of a Christmas tree or a jack-o-lantern may imply that a narrative takes place during a holiday season, etc.), where different image analysis techniques may be used to recognize objects and other elements in the plurality of two-dimensional images.

In further examples, the AS 104 may build a hierarchy of a narrative, or a narrative arc, from the extracted narrative elements. For instance, machine learning techniques may be used to identify relationships between narrative elements (e.g., a character stating, “I am hungry,” may be related to a later scene in which the character is depicted eating a slice of pizza). The AS 104 may also learn recurring narrative elements (e.g., such as recurring jokes, character interactions, and the like) and may use these recurring narrative elements to construct an entirely new narrative arc.

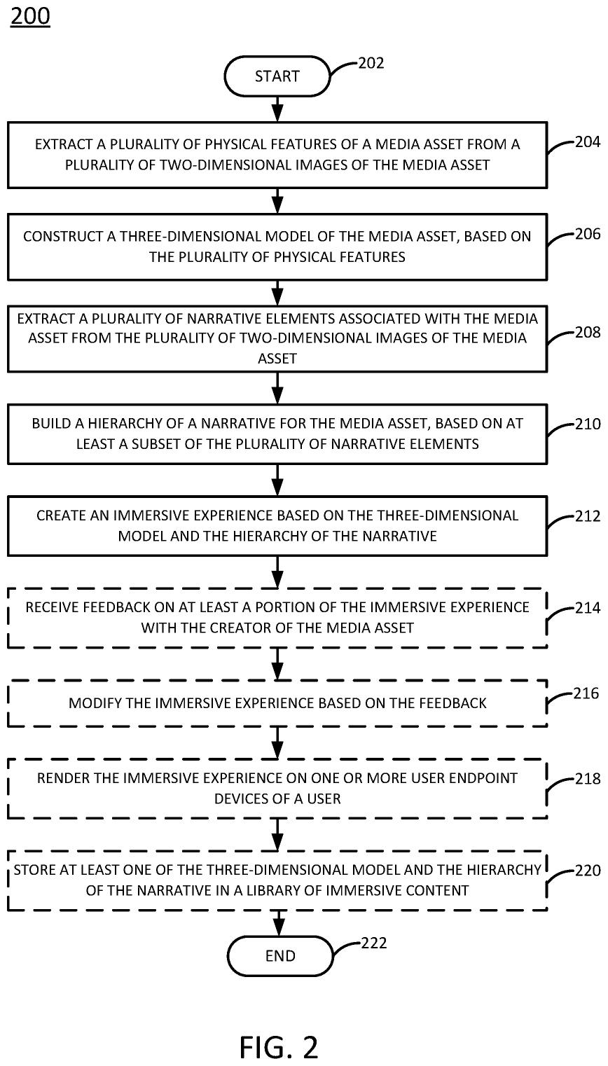

The AS 104 may deliver three-dimensional models for one or more media assets, as well as one or more hierarchies of narratives that are constructed from the narrative elements, to one of the user endpoint devices 108, 110, 112, and/or 114 as part of an immersive experience. For instance, as discussed above, the immersive experience may allow a user to interact with the three-dimensional models of the media assets within some simulated narrative arc as part of the experience. Thus, the user may be presented with an opportunity to experience previously static, two-dimensional media content in a new, more immersive manner. The immersive experience may also provide creators of media content with a new way to leverage existing two-dimensional media assets to participate in emerging media consumption trends. One example of a method for transforming static two-dimensional images into immersive computer generated content is discussed in greater detail in connection with FIG. 2.

The DB 106 may store a plurality of images extracted from static, two-dimensional media content such as frames of comic strips, pages of illustrated books, frames or pages of graphic novels, paintings, drawings, or the like. The plurality of images may be stored in digital form and tagged with metadata. The metadata may indicate, for example, the sources of the images (i.e., the series or instances of media content from which the images were extracted, such as the comic strip series, the specific strip in the series, the narrative arc to which the specific strip belongs, etc.), the media assets depicted in the images (characters, objects, etc.), and the like. This may help the AS 104 to identify images that belong to the same source media content, that depict the same media assets, that depict variants of the same media assets, and the like.

In another example, the DB 106 may store templates for constructing three-dimensional models of media assets. For instance, as discussed above, the AS 104 may construct a three-dimensional model of a media asset based on a plurality of static two-dimensional images of the media asset. One way in which the AS 104 may construct the three-dimensional model is to map portions of the plurality of two-dimensional images onto a template, or generic three-dimensional model, as discussed in further detail below. Thus, the DB 106 may store the templates that are available for use in constructing the three-dimensional models.

The DB 106 may also store the completed three-dimensional models that are constructed by the AS 104. For instance, the DB 106 may serve as a library for the three-dimensional models constructed by the AS 104. The three-dimensional models stored in the DB 106 may be tagged with metadata to indicate the media asset that is modeled (e.g., character, object, etc.), media content in which the media asset appears (e.g., series, instance(s) of series, narrative arcs of series, etc.), other media assets with which the media asset frequently appears or interacts, and the like.

In one example, the DB 106 may comprise a physical storage device integrated with the AS 104 (e.g., a database server or a file server), or may be attached or coupled to the AS 104, in accordance with the present disclosure. In one example, the AS 104 may load instructions into a memory, or one or more distributed memory units, and execute the instructions for transforming static two-dimensional images into immersive computer generated content, as described herein.

In one example, one or more servers 128 and databases (DBs) 126 may be accessible to the AS 104 via Internet 124 in general. The servers 128 may include Web servers that support physical data interchange with other devices connected to the World Wide Web. For instance, the Web servers may support Web sites for Internet content providers, such as social media providers, ecommerce providers, service providers, news organizations, and the like. At least some of these Web sites may include sites where two-dimensional static images of media assets, or additional information related to the media assets which may help to guide construction of three-dimensional models, may be obtained.

In one example, the databases 126 may store static two-dimensional images of media assets and/or computer-generated three-dimensional models of the media assets. For instance, the databases 126 may contain information that is similar to the information contained in the DB 106, described above.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an example method 200 for transforming static two-dimensional images into immersive computer generated content, in accordance with the present disclosure. In one example, steps, functions and/or operations of the method 200 may be performed by a device as illustrated in FIG. 1, e.g., AS 104, a UE 108, 110, 112, or 114, or any one or more components thereof. In one example, the steps, functions, or operations of the method 200 may be performed by a computing device or system 300, and/or a processing system 302 as described in connection with FIG. 3 below. For instance, the computing device 300 may represent at least a portion of the AS 104 in accordance with the present disclosure. For illustrative purposes, the method 200 is described in greater detail below in connection with an example performed by a processing system, such as processing system 302.

The method 200 begins in step 202 and proceeds to step 204. In step 204, the processing system may extract a plurality of physical features of a media asset from a plurality of two-dimensional images of the media asset. In one example, the media asset may comprise a character or an object, and the plurality of two-dimensional images may comprise images from different instances of a two-dimensional visual media. For instance, the two-dimensional visual media may comprise a comic strip series, where the plurality of two-dimensional images comprises frames from different comic strips within the comic strip series. In other examples, the two-dimensional visual media may comprise an illustrated book or series of books, a graphic novel or series of graphic novels, a two-dimensional animated work comprising a plurality of cells, or other types of two-dimensional visual media.

The media asset may comprise a regular or recurring character within the comic strip series (e.g., a protagonist, an antagonist, a sidekick or comic relief character, an animal, etc.). Alternatively, the media asset may comprise a regular or recurring object within the comic strip series (e.g., a vehicle, a building, an accessory, etc.). Where the media asset is a character, physical features of the media asset may comprise features such as the character's general appearance (e.g., height, weight, hair color, eye color, etc.), the character's different facial expressions (e.g., happy, scared, angry, sad, surprised, etc.), the character's mannerisms (e.g., repeated gestures), the character's costumes (e.g., repeated outfits, accessories, colors worn, etc.), unique physical characteristics (e.g., birthmarks, scars, etc.), and other physical features. Where the media asset is an object, physical features of the media asset may comprise a type of the object (e.g., vehicle, building, accessory, weapon, etc.), a shape of the object, a color of the object, a size of the object, unique physical characteristics of the object (e.g., a specific bumper sticker on a car or a dent in the car's hood, an unusual edifice on a building), and other physical features.

In one example, the physical features may be extracted using one or more image analysis techniques. For instance, facial features and expressions of a human (or human-like) character may be extracted using one or more facial recognition and analysis techniques that are capable of locating a facial region in an image and/or locating different elements of the facial regions (e.g., eyes, nose, mouth, hair, ears, etc.). Physical features of objects of other non-human assets could be extracted using one or more object recognition techniques. The recognition techniques may be provided with one or more sample images of the media asset to facilitate location of the media asset in the plurality of two-dimensional images.

In step 206, the processing system may construct a three-dimensional model of the media asset, based on the plurality of physical features that was extracted in step 204. For instance, in one example, the processing system may select a template to serve as a starting point. The template may comprise a generic three-dimensional model of a same type as the media asset. For instance, if the media asset is a human character (or a character with human-like features, such as humanoid alien, an android, an anthropomorphized animal, or the like), the template may comprise a generic “human” template.

The processing system may then customize the template by mapping the physical features of the media asset onto the template. For instance, where the media asset is a human character, a “human” template may be adjusted (e.g., using sliders or another graphical user interface element) to reflect the height, weight, and/or body type of the character. Furthermore, portions of the two-dimensional images may be mapped (e.g., superimposed or modeled) onto the adjusted template, so that the template resembles the character. For instance, the template may be customized to have the same hair style and color, the same color eyes, the same nose shape, and other physical features (e.g., freckles, birth marks, scars, etc.). Furthermore, the template may be customized to include a costume and/or accessories associated with the character (e.g., a uniform, a specific dress, a particular hat or pair of shoes, etc.). In one example, different views of the physical features (e.g., views of the physical features from different perspectives, angles, or fields of view) may be “stitched” together so that the three-dimensional model resembles the media asset no matter which angle the three-dimensional model is viewed from.

In further examples, mannerisms and/or physical behaviors of the media asset may be further mapped onto the three-dimensional model. For instance, if the media asset is a human character, the three-dimensional model may be adapted to emulate the character's gait, gestures (e.g., frequently playing with their hair, cracking their knuckles, playing with a piece of jewelry, etc.), and other physical behaviors. If the media asset is an object such as a car, the three-dimensional model could be adapted to emulate whether the car moves fast or slowly, whether an unusual amount of physical exhaust is emitted from the tailpipe, and other physical behaviors.

It should be noted that the use of a template represents only one way in which a three-dimensional model may be constructed using physical features extracted from a plurality of two-dimensional images. For instance, a three-dimensional model could also be constructed by compositing a plurality of two-dimensional images (or portions of two-dimensional images), without a template. In another example, machine learning techniques may be used to guide the process of constructing the three-dimensional model using the extracted physical features. For instance, machine learning could be used to map the extracted physical features to other, existing three-dimensional models that may share similarities with the media asset.

It should further be noted that the three-dimensional model may not comprise a single representation of the media asset. For instance, where the media asset is a human character, the three-dimensional model may model or simulate a plurality of different facial expressions and/or mannerisms for the character. As an example, the three-dimensional model may include different facial expressions of the character, such as happy, sad, angry, scared, and the like and may emulate a different gait when walking versus running. In one example, observed facial expressions of the human character may be mapped to stored facial expressions in a database, in order to determine which of the human character's facial expressions demonstrate happiness, sadness, anger, and the like. The emotion corresponding to a facial expression could also be detected from textual clues. For instance, if a character in a frame of a comic strip series says, “I'm scared,” then the facial expression of the character in that frame may be assumed to demonstrate fear.

It should be further noted that the greater the number of images of the media asset the processing system has to work with in step 204, the better, as a diverse set of images of the same media asset allows for modeling a broader range of characteristics of the media asset, which will ultimately result in a more faithful three-dimensional rendering of the media asset.

In step 208, the processing system may extract a plurality of narrative elements associated with the media asset from the plurality of two-dimensional images of the media asset. In one example, a narrative element may comprise a recurring gag, a recurring character interaction, a catchphrase, or an ongoing narrative arc that involves the media asset. For instance, if the media asset is a human character, the character may have a particular line of dialogue that he repeats often, or a facial expression that he makes often. Alternatively, the character may interact with another character in a unique or specific way.

In one example, a narrative element may be extracted from text of the plurality of two-dimensional images. For instance, where the plurality of two-dimensional images comprise frames of a comic strip series or graphic novel, the narrative element may be extracted from captions or character speech or thought bubbles. Where the plurality of two-dimensional images comprise pages of an illustrated book, the narrative element may be extracted from the text of the book. In one example, analysis techniques including natural language processing and semantic analysis may be used to extract meaning from dialogue, text, and the like. Understanding the meaning of the dialogue and text may help the processing system to identify a type or context of the narrative element (e.g., a funny interaction versus a battle).

In another example, non-text visual cues may also help to identify narrative elements. For instance, a superhero in a comic strip series may frequently be depicted fighting the same villain or performing the same actions (e.g., transforming from an alter ego into a superhero inside a telephone booth or by spinning in place).

In a further example, non-text visual cues could be detected over a series of consecutive frames of a comic strip series (or other instances of two-dimensional media) and used to infer a narrative element. For instance, if multiple consecutive frames of the comic strip series depict a superhero trading punches with a villain, these frames could be inferred to be part of a narrative element involving a battle between the superhero and the villain. Similarly, if multiple consecutive frames of the comic strip series depict a superhero growing weak after being exposed to an object, these frames could be inferred to be part of a narrative element involving the superhero losing his super powers. If multiple consecutive frames of a comic strip series show a character daydreaming about different types of food, then these frames could be inferred to be part of a narrative element involving the character looking for a snack. If a set of consecutive frames shows men in masks running out of a bank, jumping into a car, and being chased by police in that order, then these frames could be inferred to be part of a narrative element involving a bank robbery. Thus, simply by observing the actions of the characters and individuals appearing in the two-dimensional media over a window of time, a narrative element can be inferred.

Non-text visual cues from which narrative elements may be extracted may also include character facial expressions (e.g., if a character is depicted crying, this may indicate a sad event), movement lines (e.g., lines to indicate that a character is moving very quickly, leaning abruptly away from something, shivering, etc.), and other visual cues which may emphasize or guide an overall narrative arc. For instance, if movement lines show a comic strip character shivering from being cold, this may indicate that a villain who has the power to freeze things may be nearby.

Further examples of methods for inferring narrative elements from media content are described in U.S. Pat. No. 9,769,524, which is herein incorporated by reference. Any of the techniques disclosed in U.S. Pat. No. 9,769,524 may be used in connection with step 208 to augment the extraction of narrative elements.

In step 210, the processing system may build a hierarchy of a narrative for the media asset, based on at least a subset of the plurality of narrative elements extracted in step 208. In one example, data models may be used to help to identify narrative elements that may be part of the same narrative arc, as well as an order in which the narrative elements may occur. For instance, a character in a comic strip stating, “I am hungry” may be related to a loose narrative about eating lunch, going hunting, cooking a meal, or the like. A villain stating that he will get revenge on a superhero may be related to a later narrative involving a battle between the villain and the superhero.

In one example, building of a narrative hierarchy may also include determining audio elements that could be part of the three-dimensional model. For instance, character voices, object noises (e.g., a car or motorcycle with a distinctive engine noise), background noises, and the like may all be examples of audio elements that may be incorporated as part of a three-dimensional model.

In step 212, the processing system may create an immersive experience based on the three-dimensional model constructed in step 206 and the hierarchy of the narrative built in step 210. For instance, the immersive experience may comprise a media that can be presented to a user via an immersive display (e.g., a head mounted display, a stereoscopic display, or any other types of display that, along or in combination with other devices, are capable of presenting an immersive experience to a user). In one example, the immersive experience may allow the user to interact with the three-dimensional model, e.g., such that an interaction with the media asset is simulated. In another example, the interaction of the user with the three-dimensional model may occur within the hierarchy of the narrative that is built. For instance, the immersive experience may allow the user to assist a superhero with a mission to locate a villain, to drive a famous fictional vehicle, or to participate in some other sort of narrative involving a character or object.

In optional step 214 (illustrated in phantom), the processing system may receive feedback on at least a portion of the immersive experience with the creator (or owner) of the media asset. For instance, the creator may be an animator or illustrator who created at least some of the images of the plurality of two-dimensional images of the media asset. In one example, the content creator may provide feedback on the three-dimensional model of the media asset. For instance, the content creator may suggest that certain visual changes be made to the three-dimensional model (e.g., a character would never wear a hat of a particular baseball team). The content creator may also suggest that certain changes be made to a behavior of the three-dimensional model (e.g., a character should slouch more when he walks, or his voice should be deeper). The creator's feedback may also be solicited where the processing system cannot, for example, disambiguate between two or more choices for the immersive experience (e.g., how wide a character's smile should be, or what shade the character's hair should be).

In optional step 216 (illustrated in phantom), the processing system may modify the immersive experience based on the feedback received in step 214. For instance, the processing system may modify the three-dimensional model of a character to wear a different hat or to speak in a deeper voice. Thus, the modifying of the immersive experience based on the feedback may help the processing system to create an immersive experience that is more artistically faithful to the original two-dimensional media on which the immersive experience is based.

In optional step 218 (illustrated in phantom), the processing system may render the immersive experience on one or more user endpoint devices of a user. For instance, the processing system may send data and signals to an immersive display that cause the immersive display to present the immersive experience to the user. In one example, rendering the immersive experience may involve extrapolating between a set of narrative elements in order to bridge any “gaps” that may exist in the original two-dimensional media content. For instance, where the plurality of two-dimensional images comprise frames of a comic strip series, two narrative elements may have been identified in the plurality of two-dimensional images. However, due to the nature of comic strips, the original two-dimensional content may not explicitly show how to get from one narrative element (e.g., a super hero transforming from his alter ego) to another narrative element (e.g., the super hero fighting a villain). Thus, rendering the immersive experience may include rendering events to fill in any gaps between narrative elements of the overarching hierarchy of the narrative. Machine learning techniques such as convolution neural networks (CNNs) or generative adversarial networks (GANs) could be used to infer the most natural ways to fill the gaps.

In one example, rendering the immersive experience may involve adjusting at least one of the three-dimensional model and the hierarchy of the narrative to adapt to the capabilities of the one or more user endpoint devices. For instance, the sizing of the three-dimensional model may be adjusted to fit to the display capabilities of the user endpoint device, or an audio element of hierarchy of the narrative may be modified for play over the audio system of the user endpoint device.

The immersive experience could also be adjusted responsive to user preferences, which may be determined from a profile for the user. For instance, the processing system could substitute a hat of the user's favorite baseball team for a default hat that is worn by a three-dimensional model of a character.

In optional step 220 (illustrated in phantom), the processing system may store at least one of the three-dimensional model and the hierarchy of the narrative in a library of immersive content. The library of immersive content may be specific to the media in which the media asset appears. For instance, the media asset may comprise one character of several characters that are part of a comic strip series, where the library of immersive content for the comic strip series includes three-dimensional models for at least some of the several characters.

The method 200 may end in step 222.

Thus, examples of the method 200 may be used to generate immersive experiences from static, two-dimensional media content, thereby providing users with a new way of experiencing the content and creators with a way to potentially engage new users. A diverse set of images of a media asset associated with the two-dimensional content may be processed and analyzed to extract physical and behavioral features of the media asset, resulting in an immersive experience that remains artistically faithful to the original, two-dimensional media content.

Moreover, by extracting narrative elements from the two-dimensional media content, and using the narrative elements to build a hierarchy of a narrative, the immersive experience may allow a user to interact with the media asset (and may allow the media asset to interact with other media assets) in a manner that feels true to the original two-dimensional content. For instance, the method 200 may be able to determine not just the theme or context of a particular interaction, but how the interaction is influenced by or related to other interactions (e.g., how certain characters tend to play off of each other or interact in certain contexts).

Further examples of the disclosure could be used to generate entirely new immersive experiences, based on entirely new narratives that were not previously seen in the original two-dimensional media content. For instance, if instances of a comic strip series tend to follow a similar narrative structure (e.g., including recurring gags, catchphrases, character moments, etc.), then examples of the present disclosure could build new narratives around that basic narrative structure, where the new narratives serve as the basis for new immersive experiences. In addition, three-dimensional models of characters could be modified to incorporate new physical features (e.g., new costumes, new hairstyles, and the like) which may be updated to reflect more modern styles.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for transforming static two-dimensional images into immersive computer generated content, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for transforming static two-dimensional images into immersive computer generated content (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for transforming static two-dimensional images into immersive computer generated content (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
extracting, by a processing system including at least one processor, a plurality of physical features of a media asset from a plurality of two-dimensional images of the media asset;
constructing, by the processing system, a three-dimensional model of the media asset, based on the plurality of physical features;
extracting, by the processing system, a plurality of narrative elements associated with the media asset from the plurality of two-dimensional images of the media asset;
building, by the processing system, a hierarchy of a narrative for the media asset, based on at least a subset of the plurality of narrative elements; and
creating, by the processing system, an immersive experience based on the three-dimensional model and the hierarchy of the narrative.

2. The method of claim 1, wherein the plurality of two dimensional images includes at least one selected from a group of: a frame of a comic strip, a frame of a graphic novel, a page of an illustrated book, a painting, and a drawing.

3. The method of claim 1, wherein the media asset comprises a character appearing in the plurality of two-dimensional images.

4. The method of claim 3, wherein the plurality of physical features includes at least one selected from a group of: an appearance of the character, a facial expression of the character, a mannerism of the character, a costume worn by the character and a unique physical characteristic of the character.

5. The method of claim 1, wherein the media asset comprises an object appearing in the plurality of two-dimensional images.

6. The method of claim 5, wherein the plurality of physical features includes at least one selected from a group of: a type of the object, a shape of the object, a color of the object, a size of the object, and a unique physical characteristic of the object.

7. The method of claim 1, wherein the constructing comprises:
selecting a template comprising a generic three-dimensional model of a same type as the media asset; and
customizing the template by mapping the plurality of physical features of the media asset onto the template, wherein the template, as customized, comprises the three-dimensional model.

8. The method of claim 7, further comprising:
mapping a physical behavior of the media asset onto the template.

9. The method of claim 1, wherein a narrative element of the plurality of narrative elements is extracted from a text element of the plurality of two-dimensional images.

10. The method of claim 1, wherein a narrative element of the plurality of narrative elements is extracted from a non-text element of the plurality of two-dimensional images.

11. The method of claim 1, wherein the subset of the plurality of narrative elements comprises narrative elements of the plurality of narrative elements that have been determined to belong to a common narrative arc.

12. The method of claim 1, further comprising:
receiving feedback on at least a portion of the immersive experience from a creator of the media asset; and
modifying the immersive experience based on the feedback.

13. The method of claim 1, further comprising:
rendering the immersive experience on a user endpoint device of a user.

14. The method of claim 13, wherein the immersive experience adds an audio element to the three-dimensional model.

15. The method of claim 13, wherein the immersive experience allows the user to interact with the three-dimensional model.

16. The method of claim 13, wherein the rendering comprises extrapolating between two narrative elements of the subset to fill a gap in the hierarchy of the narrative.

17. The method of claim 1, further comprising:
storing at least one of: the three-dimensional model and the hierarchy of the narrative in a library of immersive content.

18. The method of claim 1, wherein the building is based on a common narrative structure of media content from which the plurality of two-dimensional images is extracted.

19. A non-transitory computer-readable medium storing instructions which, when executed by a processing system including at least one processor, cause the processing system to perform operations, the operations comprising:
extracting a plurality of physical features of a media asset from a plurality of two-dimensional images of the media asset;
constructing a three-dimensional model of the media asset, based on the plurality of physical features;
extracting a plurality of narrative elements associated with the media asset from the plurality of two-dimensional images of the media asset;
building a hierarchy of a narrative for the media asset, based on at least a subset of the plurality of narrative elements; and
creating an immersive experience based on the three-dimensional model and the hierarchy of the narrative.

20. A device comprising:
a processing system including at least one processor; and
a non-transitory computer-readable medium storing instructions which, when executed by the processing system, cause the processing system to perform operations, the operations comprising:
extracting a plurality of physical features of a media asset from a plurality of two-dimensional images of the media asset;
constructing a three-dimensional model of the media asset, based on the plurality of physical features;
extracting a plurality of narrative elements associated with the media asset from the plurality of two-dimensional images of the media asset;
building a hierarchy of a narrative for the media asset, based on at least a subset of the plurality of narrative elements; and
creating an immersive experience based on the three-dimensional model and the hierarchy of the narrative.
